(19) United States
(12) Patent Application Publication
(10) Pub. No.: US 2011/0042122 A1
(43) Pub. Date: Feb. 24, 2011

(54) CABLE BINDING APPARATUS

(75) Inventors: MING-CHIH HSIEH, Tu-Cheng (TW); TSUNG-HSI LI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/623,439

(22) Filed: Nov. 22, 2009

(30) Foreign Application Priority Data
Aug. 20, 2009 (CN) 200910305875.1

(51) Int. Cl. H01B 7/00; B65B 13/18

(52) U.S. Cl. 174/135; 100/33 R

(57) ABSTRACT

A cable binding apparatus includes a flexible binding strip defining a column of teeth, a connection element, and a positioning element. The binding strip and the positioning element are both connected to the connection element. The positioning element includes a connection portion defining a through hole and a flexible block portion arranged in the through hole. The binding strip is operable to be bent freely, with a distal end of the binding strip inserted into the through hole of the positioning element. The block portion is operable to engage with one of the column of teeth, to bind cables via the binding strip.

### BACKGROUND

1. Technical Field

The present disclosure relates to binding apparatuses and, particularly, to a binding apparatus for binding cables in an electronic device.

2. Description of Related Art

In an electronic device, such as a computer, a lot of cables may be used for interconnecting different parts of the computer and unfortunately are usually disposed in a disorderly manner.

### BRIEF DESCRIPTION OF THE DRAWINGS

FIG. 1 is an isometric view of an exemplary embodiment of a cable binding apparatus, together with a circuit board, a base board, and a plurality of cables.

FIG. 2 is an isometric of the cable binding apparatus of FIG. 1.

FIG. 3 is a top plan view of the cable binding apparatus of FIG. 2.

### DETAILED DESCRIPTION

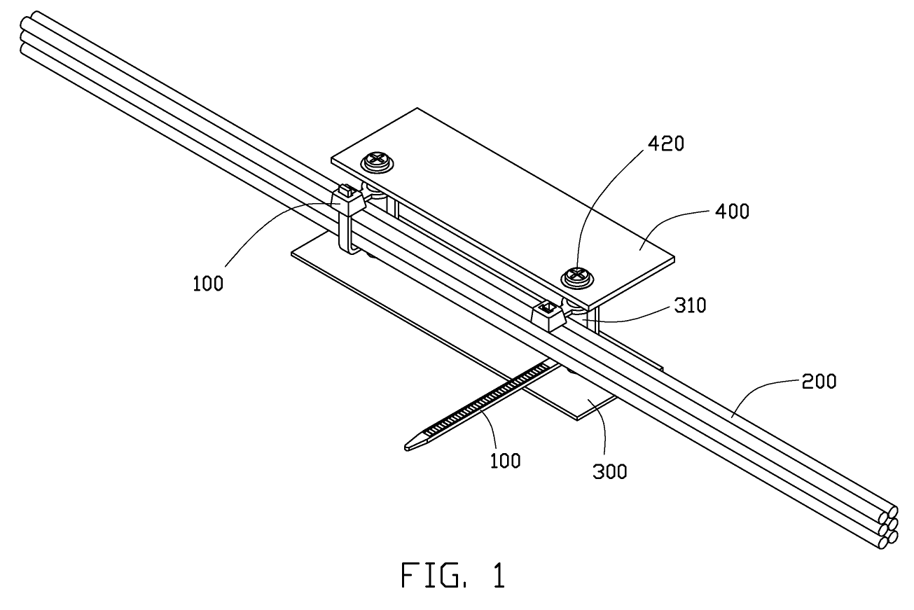

Referring to FIG. 1, an exemplary embodiment of a cable binding apparatus 100 is used to bind a plurality of cables 200 between a base board 300 and a circuit board 400 of an electronic device. The circuit board 400 is attached to distal ends of two positioning poles 310 which are fixed to the base board 300.

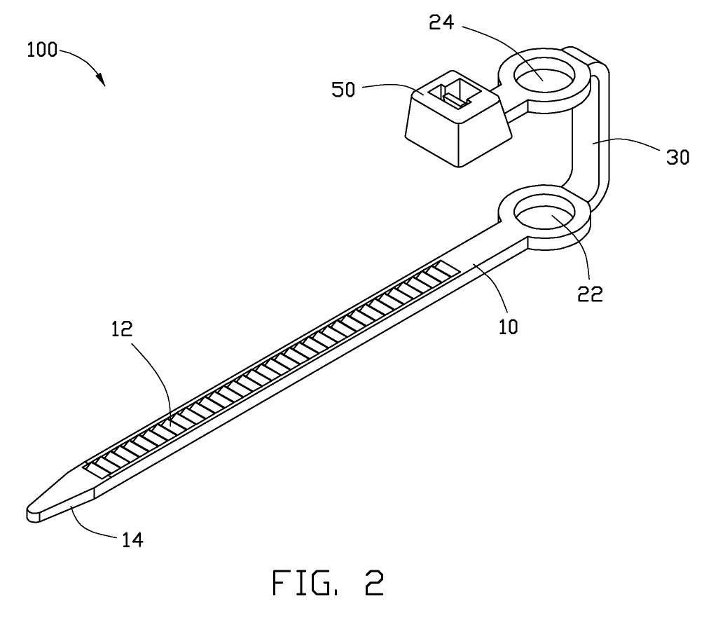

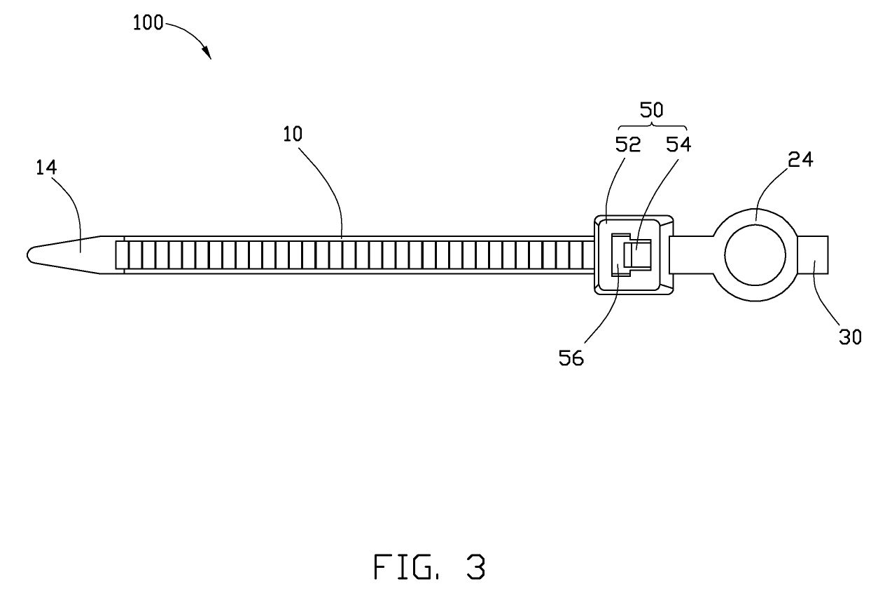

Referring to FIGS. 2 and 3, the cable binding apparatus 100 is similar to a cable tie but includes a U-shaped connection element 30 for allowing mounting the apparatus to one of the poles 310. The cable binding apparatus 100 further includes a flexible bar-shaped binding strip 10 and a positioning element 50. A column of teeth 12 is defined in the binding strip 10. A distal end 14 of the binding strip 10 is tapered. The connection element 30 includes two coaxially aligned ring-shaped positioning portions 22 and 24 extending from opposite ends of the connection element 30. The binding strip 10 is connected to the connection element 30 via the positioning portion 22. The positioning element 50 is connected to the connection element 30 via the positioning portion 24. The positioning element 50 includes a generally trapezoid-shaped connection portion 52 connected to the connection element 30. A T-shaped through hole 56 is defined in the connection portion 52, and a flexible block portion 54 is arranged in a small part of the through hole 56. The binding strip 10 can be bent freely and the distal end 14 of the binding strip 10 can be inserted into the through hole 56 of the positioning element 50. When the distal end 14 of the binding strip 10 is inserted into the through hole 56 of the positioning element 50, the block portion 54 can block the binding strip 10 preventing it from backing out, via engaging with one of the teeth 12 of the binding strip 10.

For example, the electronic device may be a computer, the base board 300 may be a bottom of a computer enclosure, the circuit board 400 may be a computer motherboard, and the cables 200 may be data cables and/or power cables of the computer. Referring to FIG. 1 again, in use, two cable binding apparatuses 100 are used. Two positioning portions 22 and 24 of each cable binding apparatus 100 fit about a corresponding positioning pole 310, and then the circuit board 400 is positioned on tops of the two positioning poles 310. Two screws 420 are passed through the circuit board 400 to engage with the corresponding positioning poles 310 of the base board 300. The cables 200 are put on the binding strips 10 of the two cable binding apparatuses 100. Each binding strip 10 is bent, with the distal end 14 of the binding strip 10 inserted into a larger part of the through hole 56 of the positioning element 50. The binding strip 10 is engaged with the positioning element 50, via engagement between one of the plurality of teeth 12 and the block portion 54. Therefore, the cables 200 are bound by the binding strip 10 and thus neatly held in place.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A cable binding apparatus comprising:
a flexible binding strip defining a column of teeth in the binding strip;
a connection element comprising a first and a second coaxially aligned ring-shaped positioning portions extending from opposite ends of the connection element, the binding strip connected to the connection element via the first positioning portion; and
a positioning element connected to the connection element via the second positioning portion, the positioning element comprising a connection portion defining a through hole and a flexible block portion arranged in the through hole;
wherein the binding strip is operable to be bent freely, with a distal end of the binding strip configured for being inserted into the through hole of the positioning element, to engage with the block portion via one of the column of the teeth.

2. The cable binding apparatus of claim 1, wherein the connection element is U-shaped.

3. The cable binding apparatus of claim 1, wherein the distal end of the binding strip is acuminate-shaped.

4. The cable binding apparatus of claim 1, wherein the positioning element is generally trapezoid-shaped, the through hole is T-shaped and comprises a small part for arranging the block portion and a great part for the binding strip passing through.

5. An electronic device comprising:
a base board comprising at least one positioning pole positioned on the base board;
a circuit board fixed on a top of each of the at least one positioning pole;
a plurality of cables; and
at least one cable binding apparatus, each of the at least one cable binding apparatus comprising:
a flexible binding strip defining a column of teeth in the binding strip;
a connection element comprising a first and a second coaxially aligned ring-shaped positioning portions extending from opposite ends of the connection element, the binding strip connected to the connection element via the first positioning portion, wherein the first and second positioning portions fitting about a corresponding one of the at least one positioning pole, with the connection element sandwiched between the base board and the circuit board; and
a positioning element connected to the connection element via the second positioning portion, the positioning element comprising a connection portion defining a through hole and a flexible block portion arranged in the through hole;
wherein the plurality of cables is between the binding strip and the positioning element of each of the at least one cable binding apparatus, a distal end of the binding strip is inserted into the through hole of the positioning element, to bind the plurality of cables by the binding strip, the block portion is operable to engage in one of the column of teeth of the binding strip.

6. The electronic device of claim 5, wherein the connection element is U-shaped.

7. The electronic device of claim 5, wherein the distal end of the binding strip is acuminate-shaped.

8. The electronic device of claim 5, wherein the positioning element is generally trapezoid-shaped, the through hole is T-shaped and comprises a small part receiving the block portion and a great part for the binding strip inserting into.
